(19) United States
(12) Patent Application Publication
(10) Pub. No.: US 2021/0115679 A1
(43) Pub. Date: Apr. 22, 2021

(54) VINYL COMPOSITION TILE AND METHOD FOR PRODUCING SAME

(71) Applicant: TAJIMA ROOFING INC., Tokyo (JP)

(72) Inventors: Shuichi ISAZAWA, Tokyo (JP); Hiroyo KONISHI, Tokyo (JP); Yasuhisa YAMADA, Tokyo (JP); Naosuke FUSE, Tokyo (JP)

(73) Assignee: TAJIMA ROOFING INC., Tokyo (JP)

(21) Appl. No.: 17/032,209

(22) Filed: Sep. 25, 2020

(30) Foreign Application Priority Data
Sep. 27, 2019 (JP) 2019-177748

(51) Int. Cl. E04F 15/10

(52) U.S. Cl. CPC E04F 15/105; C08L 23/0892; E04F 15/107

(57) ABSTRACT

This disclosure relates to vinyl composition tile that does not use phthalate or terephthalate, has many color variations with a limited number of pigments, and has clear pattern. A vinyl composition tile, comprising 100 parts by mass of a vinyl chloride resin, 400 to 600 parts by mass of calcium carbonate, and 20 to 40 parts by mass of a fatty acid alkyl ester plasticizer. A method for manufacturing vinyl composition tile, comprising the successive steps of obtaining melt mixture by heating 100 parts by mass of vinyl chloride resin and 400-600 parts by mass of calcium carbonate with 20-40 parts by mass of fatty alkyl ester plasticizer, milling the mixture to obtain plates, and punching out the plates to obtain vinyl composition tiles.

### TECHNICAL FIELD

The present invention relates generally to a resilient floor covering. More specifically, the invention is directed to vinyl composition tile comprised with vinyl resin and non-phthalate plasticizer and a method for making the same.

### BACKGROUND ART

The world's first vinyl composite tile, in commercially known as “Vinyl Composition Tile” was developed in the United States around 1940, allowing diversification of color shades, which was not possible with conventional asphalt tiles; therefore, it has become widespread worldwide and is still widely used as a floor finishing material. In addition to ASTM F1066 (USA), there are EN654 (Europe), JIS A5705 (Japan) and ISO10595 of international standards. Dimensional stability, indentation, squareness, etc. are clearly specified. Moreover, because of the small differences between countries in the specifications, it is a suitable flooring material for international distribution.

The raw material of vinyl composite tile is mainly composed of vinyl chloride resin and additives such as calcium carbonate, phthalate plasticizer and stabilizer. In the manufacturing method, after each raw material is mixed with a Banbury mixer, the method is taken to mill with a calendar roll and punches it into a tile.

However, in recent years, skeptical evaluation results on the safety and environmental impact of the raw material, phthalates, have been published, and a movement has emerged to limit the use of phthalates, mainly in Europe and the United States. This movement has led to studies to replace the vinyl tile plasticizer with other plasticizers from phthalates.

At present, terephthalate and cyclohexane are most used as alternative plasticizers of phthalate in floor finishing materials made of vinyl chloride resin, and in particular, vinyl composition tiles using di-ethyl-hexyl terephthalate (DEHT or DOTP) are sold mainly in Europe and America.

However, when a terephthalate plasticizer is used for the floor finishing material, hydrolysis occurs due to substrate moisture, and since the decomposition rate is faster than that of the phthalate, there arises a problem that the dissipation of the decomposed product increases. Non-patent literature (The Journal of the Japanese Society of Construction and Finishing, October 2015, p. 99-102) discloses that the use of terephthalate as a flooring material is unfavorable.

In view of such background, the present inventors have intensively developed a vinyl chloride resin composition applicable to a floor material without using a phthalate or terephthalate, and have previously filed a patent (Japanese Patent Application No. 2019-47303)

On the other hand, as a method of imparting a design to a vinyl composite tile, a through-chip manufacturing method, disclosed in Japanese Examined Patent Publication No. 43-2598 has been widely practiced conventionally. This method is a manufacturing method for obtaining a highly decorative vinyl composite tile by grinding the vinyl chloride resin sheet after rolling, and then re-heating and re-rolling, but in order to increase the color variation, it is necessary to prepare the number of pigments accordingly, and it has the disadvantage of increasing the cost. And there was the disadvantage that the pattern became blurred and obscured, when the melting between the milling tips was too good in the case of the through tip preparation method.

By using the vinyl chloride resin composition of the patent, the inventors have intensively promoted development to obtain a vinyl composition tile which enables phthalate free, can create a rich color variation with a limited number of pigments, and has a sharp pattern, thereby completing the present invention.

### PRIOR ART DOCUMENTS

### Patent Documents

Patent Document 1: Japanese Patent Application No. 2019-47303
Patent Document 2: Japanese Examined Patent Publication No. Sho 43-2598

### Non-Patent Documents

Non-Patent Document 1: Collections of Research Presentation Papers of Conference 2015 of Japan Society For Finishings Technology, October 2015, pages 99-102

### SUMMARY OF THE INVENTION

### Technical Problem

An object of the present invention is to provide a vinyl composition tile that has many color variations and a clear pattern using a limited number of pigments, without using phthalate or terephthalic acid.

In order to solve the above problems, the first invention is a vinyl composition tile for flooring, comprising a 100 parts by mass of a vinyl chloride resin, 400 to 600 parts by mass of calcium carbonate, and 20 to 40 parts by mass of a fatty acid alkyl ester plasticizer.

The second invention is a method for producing a vinyl composite tile, comprising the steps of:

(1) heat-kneading 100 parts by mass of a vinyl chloride resin, 400 to 600 parts by mass of calcium carbonate, and 20 to 40 parts by mass of a fatty acid alkyl ester plasticizer to obtaining a kneaded mixture,

(3) rolling the kneaded mixture to obtain a plate, and

(6) punching out the plate to obtain a vinyl composition tile.

The third invention is a method for producing a vinyl composition tile, comprising the steps of:

(A) heat-kneading 100 parts by mass of a vinyl chloride resin, 400 to 600 parts by mass of calcium carbonate, 20 to 40 parts by mass of a fatty acid alkyl ester plasticizer, and a pigment to obtain a kneaded mixture,

(B) processing the kneaded mixture into a plate shape to obtain a plate,

(C) repeating steps (A) and (B) at least once with a different type or blending amount of the pigment to obtain at least two plates having a different pigment formulation,

(D) stacking the at least two plates having a different pigment formulation to obtain a laminate,

(E) rolling the laminate,

(F) folding the rolled laminate into two or more,

(G) rolling the folded laminate,

(H) breaking the rolled laminate into a chip shape to obtain chips,

(I) heating and rolling the chips to obtain a plate, and

(J) punching out the plate obtained in step (I) to obtain a vinyl composition tile.

The present invention includes the following embodiments.

[1] A vinyl composition tile for flooring, comprising 100 parts by mass of a vinyl chloride resin, 400 to 600 parts by mass of calcium carbonate, and 20 to 40 parts by mass of a fatty acid alkyl ester plasticizer.

[2] The vinyl composition tile of [1], wherein the fatty acid alkyl ester plasticizer comprises at least one selected from the group consisting of methyl palmitate, methyl stearate, epoxidized oleic acid alkyl ester, epoxidized linoleate acid methyl ester, epoxidized linolenic acid methyl ester.

[3] The vinyl composition tile of [1] or [2], wherein the vinyl chloride resin is a mixture of an ethylene-vinyl chloride copolymer and a straight vinyl chloride resin, and a mixing ratio thereof is in a range of 1:1 to 1:3

[4] A method for producing a vinyl composition tile, comprising the steps of:

(1) heat-kneading 100 parts by mass of a vinyl chloride resin, 400 to 600 parts by mass of calcium carbonate, and 10 to 100 parts by mass of a fatty acid alkyl ester plasticizer to obtain a kneaded mixture,

(3) rolling the kneaded mixture to obtain a plate, and

(6) punching out the plate to obtain a vinyl composition tile.

[5] The method for producing a vinyl composition tile of [4], further comprising, after step (1) and before step (3),

(2) kneading a pattern material into the kneaded mixture.

[6] The method for producing a vinyl composition tile of [4] or [5], further comprising, after step (3) and before step (6),

(4) breaking the plate into a chip shape to obtain chips, and

(5) heating and rolling the chips to obtain a plate.

[7] A method for producing a vinyl composition tile, comprising the steps of:

(A) heat-kneading 100 parts by mass of a vinyl chloride resin, 400 to 600 parts by mass of calcium carbonate, 20 to 40 parts by mass of a fatty acid alkyl ester plasticizer, and a pigment to obtain a kneaded mixture,

(B) processing the kneaded mixture into a plate shape to obtain a plate,

(C) repeating steps (A) and (B) at least once with a different type or blending amount of the pigment to obtain at least two plates having a different pigment formulation,

(D) stacking the at least two plates having a different pigment formulation to obtain a laminate,

(E) rolling the laminate,
(F) folding the rolled laminate into two or more,
(G) rolling the folded laminate,
(H) breaking the rolled laminate into a chip shape to obtain chips,
(I) heating and rolling the chips to obtain a plate, and
(J) punching out the plate obtained in step (I) to obtain a vinyl composition tile.

### Effects of the Invention

The various embodiments provide a phthalate free vinyl composition tile. Further, the present invention provides vinyl composition tile which has a rich color variation with a limited number of pigments and has a sharp pattern. According to the present invention, it is possible to provide a vinyl composition tile which does not use a phthalate or terephthalate and has many color variations with a limited number of pigments and has a clarity pattern.

### BRIEF DESCRIPTION OF THE DRAWING

FIG. 1 is a process flow schematic of a process for making a phthalate free vinyl composition tile according to one embodiment of the present invention.

### DESCRIPTION OF EMBODIMENTS

Hereinafter, detailed description of the present invention and preferred embodiments are disclosed.

The present invention relates to a vinyl composition tile for floor finishing.

The vinyl composition tile of the present invention contains 100 parts by mass of vinyl chloride resin, 400 to 600 parts by mass of calcium carbonate, and 20 to 40 parts by mass of a fatty acid alkyl ester plasticizer.

### [Vinyl Chloride Resin]

In one embodiment, as the vinyl chloride resin in the present invention, in addition to a homo-polymer of vinyl chloride, a copolymer with another monomer copolymerized may be used. The vinyl chloride resin may be used alone or as a mixture of 2 or more thereof. Further, although there is no particular limitation on the method for producing a vinyl chloride resin and the degree of polymerization, in order to suitably obtain a through-chip pattern, a mixture of ethylene-vinyl chloride copolymer and a straight vinyl chloride resin, and a mixing ratio thereof is preferably 1:1 to 1:3, more preferably 1:1 to 1:2.5 Further, a straight vinyl chloride resin to be mixed is preferably a vinyl chloride resin synthesized by suspension polymerization having a degree of polymerization of about 700.

### [Fatty Acid Alkyl Ester Plasticizer]

As fatty acid alkyl ester plasticizers in the present invention, at least one plasticizer, which is selected from the group consisting of methyl palmitate, methyl stearate, epoxidized oleic acid alkyl ester, epoxidized linoleate acid methyl ester, epoxidized linolenic acid methyl ester and linolenic acid esters epoxydized with unsaturated groups, is preferred, and fatty acid alkyl ester plasticizers, which are obtained by hydrolyzing, esterifying and epoxydized vegetable oils, are preferred. The fatty acid alkyl ester plasticizer preferably contains at least one selected from the group consisting of methyl palmitate, methyl stearate, an oleic acid ester obtained by epoxidizing an unsaturated group, methyl linoleate obtained by epoxidizing an unsaturated group, and methyl linolenate obtained by epoxidizing an unsaturated group. When a mixture of two or more fatty acid alkyl ester plasticizers is used, it is particularly preferable to use at least one species selected from the group consisting of palmitate and stearate esters combined with at least one species selected from the group consisting of oleate esters epoxydized with unsaturated groups, linoleate esters epoxydized with unsaturated groups, and linolenic acid esters epoxydized with unsaturated groups. The oleic ester obtained by epoxidizing an unsaturated group is also referred to as a cis-9,10-epoxyoctadecanoic ester, and preferred examples thereof include cis-9,10-epoxyoctadecanoic acid methyl, cis-9,10-epoxyoctadecanoic acid ethyl, and the like. Linoleic acid esters obtained by epoxidizing unsaturated groups are also referred to as 9,10:12,13-diepoxyoctadecanoic acid esters, and preferred examples thereof include methyl 9,10:12,13-diepoxyoctadecanoic acid and ethyl 9,10:12,13-diepoxyoctadecanoic acid. The linolenic acid ester in which the unsaturated group is epoxidized is also referred to as a 9,10:12,13:15,16-triepoxy octadecanoate ester, and preferred examples thereof include 9,10:12,13:15,16-triepoxy octadecanoate methyl9,10:12,13:15,16-triepoxy octadecanoate, and the like.

The amount of the fatty acid alkyl ester plasticizer to be blended is 20 to 40 parts by mass, preferably 25 to 35 parts by mass, per 100 parts by mass of the vinyl chloride resin. The indentation values (Indentation and Residual indentation) and flexibility of vinyl tiles of national product specifications can be satisfied by placing the amounts of fatty acid alkyl ester plasticizers in this range.

### [Calcium Carbonate]

The calcium carbonate in the present invention is blended as filler. The calcium carbonate is preferably used by mixing 2 kinds having different particle diameters, and the blending amount thereof is 400 to 600 parts by mass, preferably 450 to 550 parts by mass, per 100 parts by mass of the vinyl chloride resin. By setting the blending amount of calcium carbonate within this range, it is possible to satisfy the indentation value (Indentation and Residual indentation) and flexibility of the vinyl tile of the national product specification standard.

### [Pattern Material]

The vinyl composition tile of the present invention preferably comprises a pattern material. Diverse patterns (designs) can be produced by the inclusion of patterning materials. Examples of the pattern material include a vinyl chloride resin containing a color pigment, a vinyl chloride resin containing a color tone pigment and a plasticizer, and a vinyl chloride resin containing a color tone pigment and a plasticizer and a filler, but is preferably a chip material (vinyl chloride resin piece) of about several mm to several 10 of mm which is approximated to the composition of a composite tile. The amount of the pattern material to be blended is preferably 0.1 to 10 parts by mass, and more preferably 0.5 to 5 parts by mass, per 100 parts by mass of the vinyl chloride resin. By setting the blending amount of the pattern material within this range, a preferable design is obtained as a flooring material.

### [Pigment]

The vinyl composite tile of the present invention preferably comprises a pigment. Inclusion of pigments allows you to obtain a wealth of color variations. The pigment is not particularly limited, and inorganic pigments such as iron oxide, Titanium Dioxide, and molybdenum, and organic pigments such as azo pigments, isoindolinones, and dioxazine violet can be used. The amount of the pigment to be blended is preferably from 0.1 to 10 parts by mass, more preferably from 0.5 to 5 parts by mass, per 100 parts by mass of the vinyl chloride resin. By setting the blending amount of the pigment within this range, the color variation and the cost can be balanced.

### [Stabilizer]

The vinyl composite tile of the present invention preferably comprises a stabilizer. As the stabilizer, for example, a stabilizer obtained by blending a metal such as barium, zinc, or calcium with a metal soap-based stabilizer derived from a fatty acid such as lauric acid or Stearic Acid, a lubricant, an antioxidant, an auxiliary agent, or the like can be used. The amount of the stabilizer to be added is not particularly limited, but is preferably from 0.1 to 5 parts by weight per 100 parts by weight of the vinyl chloride resin. By setting the blending amount of the stabilizer within this range, the stability of the color and the cost are balanced.

### [Additives]

In addition, additives such as an antistatic agent, an antibacterial agent, a processing aid, and an ultraviolet absorber may be added.

### [Method for Producing a Vinyl Composition Tile]

The vinyl composition tile of the present invention can be produced by weighing each ingredient, heating and kneading it with a Banbury mixer, rolling the heated mixture with a calendar roll, cooling, and then punching it into a tile shape by punching processing.

In one preferred embodiment, for obtaining more color variations with fewer pigments, it is preferable to create a lamellar structure that has been milled into a multilayered state by a process of laminating over two layers and folding over two times, and then reheating and re-rolling.

More specifically, a method of manufacturing a vinyl composite tile according to a first embodiment of the present invention includes the following steps.

(1) A step of obtaining a kneaded product by heating and kneading 100 parts by mass of a vinyl chloride resin, 400 to 600 parts by mass of calcium carbonate, and 20 to 40 parts by mass of a fatty acid alkyl ester plasticizer

(2) Process of kneading pattern material into kneaded material

(3) Process of obtaining a plate by rolling a kneaded product

(4) Step of grinding a plate into a chip to obtain a tip

(5) Step of heating and rolling the chip to produce a plate

(6) Process of punching out a plate to obtain a vinyl composite tile

However, steps 2, 4, and 5 are not essential and may be omitted.

Step 1 is a step of obtaining a kneaded product by heating and kneading 100 parts by mass of a vinyl chloride resin, 400 to 600 parts by mass of calcium carbonate, and 10 to 100 parts by mass of a fatty acid alkyl ester plasticizer.

The kneading can be performed using a Banbury mixer, a Henschel mixer, a ribbon blender, or the like.

The temperature at the time of kneading is preferably 150 to 220° C., more preferably 170 to 200° C., and still more preferably 175 to 190° C. It has the advantage of being able to stably produce smelt by keeping the temperature within this range.

The kneading time is preferably 1 to 5 minutes, more preferably 2 to 4 minutes, and still more preferably 2.5 to 3.5 minutes. By setting the kneading time within this range, the kneaded product can be stably produced.

Step 2 is a step of kneading a pattern material into a kneaded product.

The method of kneading the pattern material is not particularly limited, and for example, a mixing roll, a feeder loader, a kneader, or the like can be used.

Step 3 is the process of rolling smelt to obtain plates.

Rolling may be performed with, but not limited to, calendar rolls, rolling presses, etc.

The thickness of the plate is preferably from 1 to 7 mm, more preferably from 1.5 to 5.0 mm, and even more preferably from 1.8 to 3.2 mm. Plate thicknesses can be within this range to meet the product specification for vinyl composition tiles in each country.

Step 4 is a step of pulverizing a plate-like material into a chip to obtain a chip.

Crushing may be performed with, but not limited to, crushers, rotoplexes, etc.

The shape and dimensions of the chip may be exemplified by, but not limited to, 3-30 mm square cubes, oblate squares, oblate rectangles, oblate irregular shapes, and the like.

Step 5 is the process of heating and rolling the tip to obtain a plate.

The heating temperature is preferably from 150 to 250° C., more preferably from 160 to 220° C., and still more preferably from 175 to 200° C. By the heating temperature within this range, the chips to each other are appropriately melt-connected, suitable chips for rolling is obtained.

Rolling may be performed with, but not limited to, calendar rolls, rolling presses, etc.

The thickness of the plate obtained by rolling is preferably, but not limited to, 1 to 7 mm, more preferably 1.5 to 5 mm, and still more preferably 1.8 to 3.2 mm By setting the thickness of the plate-like material within this range, it is possible to satisfy the product specification standard of the composition vinyl tile of each country.

Step 6 is the process of punching out a plate to obtain a vinyl composition tile. The punching can be performed by using, for example, punching, die cutting, bike cutting, or the like.

The shape and dimensions of the resulting vinyl composition tiles are, but are not limited to, square of 25-50 cm of side length, rectangle of 10-20 cm longitudinal, and 50-90 cm transverse.

When giving a pattern to a vinyl composition tile, change the type or amount of patterning material, carry out two or more steps, prepare different mixtures of two or more patterned materials, each mill to produce two or more plates (step 3), crush two or more plates to produce two or more chips, respectively (step 4), mix two or more chips, heat, mill them into plates (step 5), and punch out the plates to produce a vinyl composite tile (step 6).

A method of manufacturing a vinyl composite tile according to a second embodiment of the present invention includes the following steps.

(A) A process for obtaining a kneaded product by heating and kneading 100 parts by mass of a vinyl chloride resin, 400 to 600 parts by mass of calcium carbonate, 20 to 40 parts by mass of a fatty acid alkyl ester plasticizer, and a pigment

(B) Process of processing smelt into plates to obtain plates

(C) A step of repeating Step A and Step B at least 1 times by changing the type or the blending amount of the pigment, and summing up to obtain different plates of at least 2 pigment formulations

(D) Step of stacking different plates of at least two pigment formulations to obtain a laminated body

(E) Step of rolling the laminated body

(F) Step of folding the rolled laminate into two or more

(G) Step of rolling the folded laminate

(H) Step of pulverizing the rolled laminate into chips to obtain chips

(I) Step of heating and rolling the chip to produce a plate

(J) Process of punching out a plate obtained in step I to obtain a vinyl composition tile

Step A is a step of obtaining a kneaded product by heating and kneading 100 parts by mass of a vinyl chloride resin, 400 to 600 parts by mass of calcium carbonate, 20 to 40 parts by mass of a fatty acid alkyl ester plasticizer, and a pigment.

The kneading can be performed similarly to the kneading in Step 1.

Step B is the process of processing mixture into plates to obtain plates.

Methods for processing into plates are not limited, but can be done using, for example, warming rolls and scrapers, rolling presses.

The thickness of the plate is preferably 10 to 150 mm, more preferably 20 to 100 mm, and even more preferably 50 to 80 mm. The thickness of the lamina becomes within this range, and the laminated volume is easy to be obtained in the lamination process of the after process.

Step C is a step of repeating Step A and Step B at least 1 times by changing the type or the blending amount of the pigment, and collectively obtaining different plate-like substances of at least 2 kinds of pigment blending.

The number of times of repeating Step A and Step B is not limited, but is preferably 1 or 2, and more preferably 2 That is, more preferably, different plate-like products of 3 kinds of pigment formulation are produced.

Step D is a step of stacking different plates of at least 2 pigment formulations to obtain a laminate.

Although there is no particular limitation on the method of stacking, for example, first, a vinyl chloride resin, a calcium carbonate, a fatty acid alkyl ester plasticizer, and a pigment are heated and kneaded to prepare a kneaded product, and the kneaded product is processed into a plate shape to produce a first plate shape, and then, using the same apparatus, a vinyl chloride resin, a calcium carbonate, a fatty acid alkyl ester plasticizer, and a pigment are heated and kneaded to prepare a kneaded product, and the kneaded product is processed into a plate shape to prepare a second plate shape, and is superposed on the first plate shape. When a 3 layer laminate is produced, further, a kneaded product is prepared by heating and kneading a vinyl chloride resin, a calcium carbonate, a fatty acid alkyl ester plasticizer, and a pigment by changing the type or the blending amount of the pigment using the same device, and the kneaded product is processed into a plate shape to produce a third plate shape, and is superposed on the second plate shape to obtain a 3 layer laminate.

A more complex pattern can be obtained by creating two-or three-layered laminated volumes.

Step E is a step of rolling the laminated body.

Rolling may be performed with, but not limited to, calendar rolls, rolling presses, etc.

The thickness of the laminated volume after rolling is preferably 10-150 mm, more preferably 20-100 mm, and even more preferably 50-80 mm By placing the thickness of the laminated volume after rolling within this range, it is easy to fold the posterior process, and the design of the more favorable form is obtained.

Step F is a step of folding the rolled laminated body into two or more.

The folding method can fold the laminate by, for example, but not by limiting, moving the laminate emerging from the rolling device over the conveyor during travel and reversing the traveling direction of the conveyor in the middle. When folded into three, it is sufficient to move the conveyor over the conveyor traveling in the positive direction, reverse the traveling direction of the conveyor when one-third of the length of the laminate rides on the conveyor to run the conveyor in the reverse direction, and reverse the traveling direction of the conveyor when two-thirds of the length of the laminate rides on the conveyor to run the conveyor in the positive direction. Folding more than one yield, more preferred design.

Step G is the process of rolling a folded laminate.

Rolling may be performed with, but not limited to, calendar rolls, rolling presses, etc.

The thickness after rolling is preferably from 1 to 7 mm, more preferably from 1.5 to 5 mm, and even more preferably from 1.8 to 3.2 mm. The thickness after rolling, by within this range, to satisfy the product specifications of each country and, in the case of pulverization and reheat rolling, grindability, the design of the tile is improved.

Step H is the process of milling a milled lamellar into a chip to obtain a chip.

The pulverization can be performed in the same manner as the pulverization in Step 4.

Step I is the process of heating and rolling the tip to obtain a plate.

Step I can be carried out in the same manner as in Step 5.

Step J is the process of punching out a plate obtained in step I to obtain a vinyl composite tile.

Step J can be performed in the same manner as step 6.

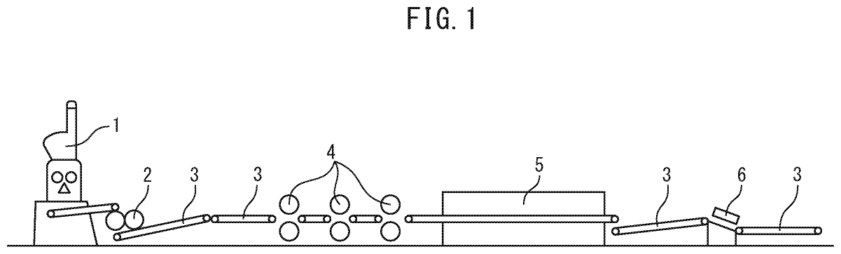

FIG. 1 shows the manufacturing process diagram of the vinyl composite tile of the present invention. However, the present invention is not limited to the manufacturing process diagram shown in FIG. 1.

A vinyl chloride resin, calcium carbonate and a fatty acid alkyl ester plasticizer, and, if desired, a pigment are charged into a Banbury mixer 1 and heated and kneaded (Step 1) The kneaded product through the mixing roll 2, is sent to the calendar roll 4 by the conveyor 3, and rolled by the calendar roll 4, to a plate-like material (Step 3). Plates are passed through an annealing room 5 and cured. Annealing room 5 is not essential. The plate, leaving the annealing room 5, is punched with a punch 6 to obtain a vinyl composite tile (Step 6).

### EXAMPLES

Hereinafter, the present invention is specifically described by way of Examples, but the present invention is not limited to such Examples only.

### [Raw Materials]

The raw materials used in the example are as follows:

Vinyl chloride resin (1): Straight vinyl chloride resin made by Ningbo Chemical Co., Ltd., Brand name: TK-700, Polymerization degree 700

Vinyl chloride resin (2): ethylene-vinyl chloride copolymer manufactured by PVC Corporation, trade name: TE-650, degree of polymerization 650

Calcium Carbonate: Made by Bihoku Co., Ltd. Brand name: BF-300

Plasticizer (1): JIAAO Co., Ltd.; Brand name: E33; Substance name: Fatty acid ester mixtures

Plasticizer (2): Made by JPlus Co., Ltd., Brand name: DOP, Substance name: Bis (2-ethylhexyl) phthalate

Plasticizer (3): manufactured by J-PLUS Co., Ltd., trade name: DOTP, substance name: di-2-ethyl hexyl terephthalate

Binder resin: Arakawa Chemical Co., Ltd., trade name: AA-L Stabilizer: ADEKA Calcium/Zinc Stabilizer, Inc., Brand name: ADEKA stab(®) 593

Pattern material: A mixture of a vinyl chloride resin, a plasticizer, calcium carbonate and a pigment (azo-based pigment “Seika First” (registered trademark) manufactured by Dainippon Seika Kogyo Co., Ltd., and a composite oxide-based pigment “Dipyroxide”) manufactured by Tajima Roofing Co., Ltd

### [Manufacture of Through-Tip Tile]

A vinyl chloride resin (1) and a vinyl chloride resin (2) were mixed in the ratio of Table 1, and a composition of a composition tile was formulated by adding calcium carbonate, various plasticizers, stabilizers, and a binder there into.

After mixing each mixture with a Banbury mixer, the kneads were processed into plates with a warming roll, the patterned materials were refined with a patterned roll, and 2 mm thick plates were made in the milling process, followed by the production of approximately 2 mm-angle chips by a milling machine. The task was repeated to create a three-color chip. The first tip was made by Tajima Roofing Co., Ltd., and the amount of the patterned material was 2 mass parts compared with 100 mass parts of vinyl chloride resin. The second tip was made by Tajima Roofing Co., Ltd., and the amount of the patterned material was 4 mass parts to 100 mass parts of vinyl chloride resin. The third tip was made by Tajima Roofing Co., Ltd., and the amount of the patterned material was 6 mass parts compared with 100 mass parts of vinyl chloride resin. Three-color tips were mixed, re-heated, re-milled, and punched into tiles with punches to produce a through-tip type vinyl composition tile (30 cm longitudinal, 30 cm transverse, and 2 mm thick).

The vinyl composition tiles produced were confirmed for the presence or absence of 2-ethylhexanol dissipation according to JIS A 1901. In addition, the appearance of the stalk was visually checked, and the sharpness (good, fair, and poor) was checked. The results are given in Table 1.

TABLE 1

| | | | | | | Comparative | Comparative |
|---|---|---|---|---|---|---|---|
| | | Example 1 | Example 2 | Example 3 | Example 4 | Example 1 | Example 2 |
| Vinyl chloride resin (1) | parts by mass | 50 | 150 | 40 | 200 | 50 | 50 |
| Vinyl chloride resin (2) | parts by mass | 50 | 50 | 50 | 50 | 50 | 50 |
| Calcium carbonate | parts by mass | 500 | 1000 | 450 | 1250 | 500 | 500 |
| Plasticizer (1) | parts by mass | 27 | 13 | 24 | 68 | — | — |
| Plasticizer (2) | parts by mass | — | — | — | — | 27 | — |
| Plasticizer (3) | parts by mass | — | — | — | — | — | 27 |
| Binder resin | parts by mass | 14 | 7 | 13 | 35 | 14 | 14 |
| Stabilizer | parts by mass | 4 | 2 | 4 | 10 | 4 | 4 |

| | | | | | | |
|---|---|---|---|---|---|---|
| Vinyl resin mix ratio: (2)/(1) | 1:1 | 1:3 | 1:08 | 1:4 | 1:1 | 1:1 |
| 2-Ethylhexanal emission | No | No | No | No | Yes | Yes |
| Sharpness of pattern | very good | very good | good | good | very good | very good |

### [Manufacture of Laminated Chip Tile]

Three colored pigments of the same line shown in Table 2 were prepared, three colored pigments were each added to the formulation of Example 1 in Table 1, each processed into plates with warming rolls, and the resulting three lamellae were laminated to create a three-layered lamellae, which were further collapsed into three lamellae to yield a lamellae of a seven-layered structure 3 mm thick. This was cooled and ground, and a laminated chip of approximately 15 mm square, reheated, and re-rolled, punched into a tile shape with a punch, to produce a laminated chip type vinyl composite tile (vertical 30 cm, horizontal 30 cm, and thickness 3 mm).

TABLE 2

| | | | | B1 | B2 | B3 |
|---|---|---|---|---|---|---|
| Pigment | Supplier | Product Name | | Bright color | Mid color | Dark color |
| White TiO₂ | Ishihara Sangyo Kaisha, Ltd. | R-930 | parts by mass | 6.0 | 2.6 | 1.72 |
| Yellow Fe | LANXESS | Yellow 20 | parts by mass | 0.022 | 0.032 | 0.074 |
| Red | LANXESS | Red 110 M | parts by mass | 0.004 | 0.006 | 0.014 |
| NC Black | Mitsubishi Chemical Corporation | Carbon Black | parts by mass | 0.0016 | 0.0024 | 0.0056 |

By changing the order of the layers, it was confirmed that color variations over the number of pigment formulations could appear.

According to the present invention, it has been possible to obtain a vinyl composite tile which does not use a phthalate ester or terephthalate and has many color variations with a limited number of pigments and has a sharp pattern.

### INDUSTRIAL APPLICABILITY

The vinyl composite tile of the present invention can be suitably utilized for floor finishing of a building.

### REFERENCE SIGNS LIST

1 Banbury mixer
2 Mixing roll
3 Conveyor
4 Calendar roll
5 Annealing room
6 Punch

1. A vinyl composition tile for flooring, comprising 100 parts by mass of a vinyl chloride resin, 400 to 600 parts by mass of calcium carbonate, and 20 to 40 parts by mass of a fatty acid alkyl ester plasticizer.

2. The vinyl composition tile of claim 1, wherein the fatty acid alkyl ester plasticizer comprises at least one selected from the group consisting of methyl palmitate, methyl stearate, epoxidized oleic acid alkyl ester, epoxidized linoleate acid methyl ester, epoxidized linolenic acid methyl ester.

3. The vinyl composition tile of claim 1, wherein the vinyl chloride resin is a mixture of an ethylene-vinyl chloride copolymer and a straight vinyl chloride resin, and a mixing ratio thereof is in a range of 1:1 to 1:3

4. A method for producing a vinyl composition tile, comprising the steps of:
(1) heat-kneading 100 parts by mass of a vinyl chloride resin, 400 to 600 parts by mass of calcium carbonate, and 20 to 40 parts by mass of a fatty acid alkyl ester plasticizer to obtain a kneaded mixture,
(3) rolling the kneaded mixture to obtain a plate, and
(6) punching out the plate to obtain a vinyl composition tile

5. The method for producing a vinyl composition tile of claim 4, further comprising, after step 1 and before step 3,
(2) kneading a pattern material into the kneaded mixture.

6. The method for producing a vinyl composition tile of claim 4, further comprising, after step 3 and before step 6,
(4) breaking the plate into a chip shape to obtain chips, and
(5) heating and rolling the chips to obtain a plate

7. A method for producing a vinyl composition tile, comprising the steps of:
(A) heat-kneading 100 parts by mass of a vinyl chloride resin, 400 to 600 parts by mass of calcium carbonate, 20 to 40 parts by mass of a fatty acid alkyl ester plasticizer, and a pigment to obtain a kneaded mixture,
(B) processing the kneaded mixture into a plate shape to obtain a plate,
(C) repeating steps (A) and (B) at least once with a different type or blending amount of the pigment to obtain at least two plates having a different pigment formulation,
(D) stacking the at least two plates having a different pigment formulation to obtain a laminate,
(E) rolling the laminate,
(F) folding the rolled laminate into two or more,
(G) rolling the folded laminate,
(H) breaking the rolled laminate into a chip shape to obtain chips,
(I) heating and rolling the chips to obtain a plate, and
(J) punching out the plate obtained in step (I) to obtain a vinyl composition tile.
